(19) United States
(12) Patent Application Publication
(10) Pub. No.: US 2015/0064527 A1
(43) Pub. Date: Mar. 5, 2015

(54) ENERGY STORE COVERING MODULE AND METHOD FOR ASSEMBLYING AN ENERGY STORE COVERING MODULE

(71) Applicant: Jens Ackermann, Stuttgart (DE)

(72) Inventor: Jens Ackermann, Stuttgart (DE)

(73) Assignee: Robert Bosch GmbH, Stuttgart, DE (DE)

(21) Appl. No.: 14/391,601

(22) PCT Filed: Mar. 5, 2013
(86) PCT No.: PCT/EP2013/054416

§ 371 Date: Oct. 9, 2014

(30) Foreign Application Priority Data
Apr. 11, 2012 (DE) 10 2012 205 895.8

(51) Int. Cl. H01M 2/04; H01M 10/52

(52) U.S. Cl. CPC H01M 2/043; H01M 10/52; H01M 2220/20
USPC 429/90; 429/175

(57) ABSTRACT

An energy store covering module for covering a cell of an electrochemical energy store unit includes: a cover, which on one side has a reception orifice to a cavity for receiving a fluid exiting an electrochemical energy store, the cover having at least one lateral transfer opening which is fluidically connected to the cavity for discharging fluid present in the cavity; and at least one connecting element for connecting the cover to a further energy store covering module.

### BACKGROUND OF THE INVENTION

1. Field of the Invention

The present invention relates to an energy store covering module, to a method for assembling an energy store covering module, and to a corresponding computer program product.

2. Description of the Related Art

Today's lithium-ion batteries are configured with a so-called degassing system according to the related art. This has the function of suctioning off or absorbing the harmful and corrosive gases resulting during the destruction of the cell in the event of an overcharge or a malfunction. The gases must neither reach the passenger compartment nor be able to be deposited on adjoining cells which would result in further destruction of other cells. The cells are therefore provided with a blow-out disk, which is destroyed in the event of an overpressure in the cell, and allows the gas to exit. Up to now, a complex metal cap has been provided over the blow-out disk, the metal cap absorbing the exiting gas. Piping or tubing is implemented at the caps to collect the gas of the entire battery pack and discharge the same. In addition, the voltage of the individual cells is monitored. An additional wiring harness is thus used, which connects the battery contacts to the monitoring sensor system and relays the signals to the corresponding control unit.

At present, battery modules having different numbers of cells are used, and therefore a separate degassing unit and a separate wiring harness are required for each module size. This results in a high number of variants, expensive assemblies and increased logistical complexity.

Published German patent application document DE 10 2009 040 663 A1 describes a device for monitoring an energy store.

### BRIEF SUMMARY OF THE INVENTION

The present invention provides an energy store covering module for covering a cell of an electrochemical energy store unit, the energy store covering module having the following features:
a cover, which on one side has a reception orifice to a cavity for receiving a fluid exiting an electrochemical energy store, the cover having at least one lateral transfer opening which is fluidically connected to the cavity for discharging fluid present in the cavity; and
at least one connecting element for connecting the cover to a further energy store covering module.

The present invention further provides a method for assembling an energy store covering unit, the method including the following steps:
connecting, in a fluid-tight manner, at least one first energy store covering module to a second energy store covering module with the aid of a connecting element of the first energy store covering module, the cavity of the cover of the first of the energy store covering modules being connected to the cavity of a second of the energy store covering modules in a fluid-tight manner with the aid of the transfer opening of the first energy store covering module to form the energy store covering unit; and
attaching, in a fluid-tight manner, the formed energy store covering unit to at least one first and one second electrochemical energy store cell, so that the reception orifice of the first energy store covering module is situated adjoining an outlet opening for a fluid exiting during a defect of the electrochemical energy store cell, and so that the reception orifice of the second energy store covering module is situated adjoining an outlet opening for a fluid exiting during a defect of the second electrochemical energy store cell.

In addition, a computer program product is advantageous, having program code which may be stored on a machine-readable carrier such as a semiconductor memory, a hard disk memory or an optical memory, and which is used to carry out and/or activate steps of the method according to one specific embodiment described above or a variant thereof, if the program product is executed on a computer or a device.

A cover may be understood to mean a closure element which is provided for application or pressing onto a cell of an electrochemical energy store unit. The cover may be designed to be placed onto only a single cell (in particular one which is not subdivided further) of the electrochemical energy store unit. A recess may be understood to mean a cavity which is able to receive a fluid from the cell of the electrochemical energy store unit via the reception orifice, the fluid being able to escape from the cell via an opening of the cell during a defect. A transfer opening may be understood to mean an aperture or an opening in a side wall of the recess or of the cavity, so that the recess or the cavity is accessible for a fluid not only from a main access side having the reception orifice (which in the installed state of the cover faces the cell), but rather that a fluid which has reached the recess (or the cavity) via this main access side may also be discharged from the cover again via the transfer opening in the side wall of the cavity. A connecting element may be understood to mean an element which is provided for fixing the cover to a further energy store covering module, in particular a cover of a further energy store covering module, to create a combination of energy store covering modules (i.e., of an energy store covering unit) for covering multiple cells of an electrochemical energy store unit. Fluid-tight attaching and/or fluid-tight situating may be understood to mean pressing an energy store covering module, or the cover of the energy store covering module, onto a further energy store covering module or one or multiple cells, so that, for example, the cover is attached by a press-fit or snap-fit mounting to the further energy store covering module in question, or to the cell of the energy store in question.

The present invention is based on the finding that, using one or multiple of the above-mentioned energy store covering modules or a variant thereof, a very flexible option exists for forming a combination of energy store covering modules in the form of an energy store covering unit, and for thus being able to very flexibly cover an energy store having a different number of cells. The individual energy store covering modules may have a high degree of standardization and are thus very cost-effective to manufacture. In accordance with the different number or arrangements of cells to form an energy store, multiple of these highly standardized energy store covering modules may then be coupled or connected to each other via the connecting elements, so that a flexible covering of all cells of the energy store may be created. Such a combination of energy store covering modules to form an energy store covering unit may then be used to very easily and cost-effectively create an option for being able to absorb and discharge a fluid, such as a liquid or a gas, during a defect of one of the covered cells.

According to one specific embodiment of the present invention, the cover and the connecting element may be produced in one piece from a plastic material, in particular the cover and the connecting element being manufactured in an injection molding process. In particular a plastic material should be used for this purpose which is resistant to corrosion by a fluid from the cell. Such a specific embodiment of the present invention offers the advantage of a particularly cost-effective manufacture of the energy store covering module.

One specific embodiment of the present invention in which the cover furthermore includes at least one sealing element around the transfer opening is particularly advantageous, the sealing element in particular being situated on the particular side of the cover on which the opening is situated. Such a specific embodiment of the present invention offers the advantage that a fluid-tight connection may be established between two energy store covering modules or their covers, so that it is ensured that a fluid from one of the cells, for example, is not able to reach a passenger compartment or surroundings of the energy store outside the energy store covering modules, and cause damage there.

According to one further specific embodiment of the present invention, the energy store covering module may also include at least one further connecting element and one further transfer opening for discharging fluid present in the cavity, which in particular are situated on a side of the cover opposite the transfer opening, in particular the further transfer opening being fluidically connected to the cavity. Such a specific embodiment of the present invention offers the advantage of a very flexible and safe option for manufacturing an energy store covering unit to cover multiple cells of the energy store, so that a fluid is not able to reach the surroundings from these cells and cause damage there. Moreover a fluid channel may be formed, which is able to conduct a fluid exiting an individual cell past multiple further intact cells and, for example, to collect the same at one end of the fluid channel and discharge it.

Also favorable is one specific embodiment of the present invention in which the cover includes at least one electrically conductive signal line which is designed to transmit at least one signal of at least one sensor, the signal line including at least one interface for electrically contacting the signal line from outside the cover. The interface may in particular be situated on the particular side of the cover on which the transfer opening is situated, in particular moreover at least one sensor and/or at least one sensor interface being provided for supplying the signal, which is electrically conductively connected or connectable to the signal line. The electrically conductive signal line may in particular be embedded into the cover of the energy store covering module or be cast therein. Such a specific embodiment of the present invention offers the advantage that an electrical signal line is already embedded into the energy store covering module, the signal line being very easily able to be coupled via the interface to signal lines of further energy store covering modules in the case of a modular design of an energy store covering unit. In this way, a separate installation of a signal line along the covering of the entire energy store is preventable, which would require an additional work step and thus higher manufacturing costs.

To be able to particularly flexibly and easily interconnect multiple signal lines from multiple energy store covering modules, the cover may include at least one second interface for externally contacting the signal line, the second interface being situated in particular on a side of the cover opposite the first interface.

According to one particularly advantageous specific embodiment of the present invention, an energy store covering unit may be formed which includes at least two energy store covering modules, for example in an above-described variant, and which are connected in a fluid-tight manner with the aid of at least one connecting element of a first of the energy store covering modules, the cavity of the cover of one of the energy store covering modules being fluid-permeably connected to the cavity of a second of the energy store covering modules with the aid of the transfer opening of the energy store covering module in question.

Such a specific embodiment of the present invention offers the advantage of a very flexible design of a covering for the energy store from the highly standardized elements or modules, so that the advantages of an inexpensive manufacture of such modules are particularly relevant in such a specific embodiment.

According to one further specific embodiment of the present invention, each of the energy store covering modules may also include an electrically conductive signal line which is designed to transmit at least one signal of at least one sensor, the signal lines being electrically conductively connected to each other via interfaces of each of the energy store covering modules to form a signal bus. In this way, depending on the application scenario, a flexible covering for multiple cells of an energy store unit may be created with very few work steps, which in addition to the option of discharging fluid exiting defective cells also allows the transmission of signals or sensor signals along the covering of the cells.

According to one specific embodiment of the present invention, the present invention further creates a device which is designed to carry out, activate or implement the steps of the method according to the present invention in corresponding devices. The object of the present invention may also be achieved quickly and efficiently by this embodiment variant of the present invention in the form of a device.

A device in the present invention may be understood to mean a device which processes sensor or data signals and outputs control signals and/or data signals as a function thereof. The device may include an interface which may be designed as hardware and/or software. In the case of a hardware design, the interfaces may, for example, be part of a so-called system ASIC which includes a wide variety of functions of the device. However, it is also possible for the interfaces to be separate integrated circuits, or to be at least partially made up of discrete components. In the case of a software design, the interfaces may be software modules which are present on a microcontroller, for example, in addition to other software modules.

The present invention is described in greater detail hereafter based on the accompanying drawings by way of example.

### BRIEF DESCRIPTION OF THE DRAWINGS

FIG. 1 shows a sectional view of one exemplary embodiment of the present invention as an energy store covering module.

FIG. 2 shows a perspective or isometric illustration of a single module as an energy store covering module.

FIG. 3 shows a top view illustration onto an exemplary interconnection of three energy store covering modules according to exemplary embodiments of the present invention.

FIG. 4 shows a flow chart of one exemplary embodiment of the present invention as a method for assembling an energy store covering unit.

### DETAILED DESCRIPTION OF THE INVENTION

In the following description of preferred exemplary embodiments of the present invention, identical or similar reference numerals are used for similarly acting elements shown in the different figures, and a repeated description of these elements is dispensed with.

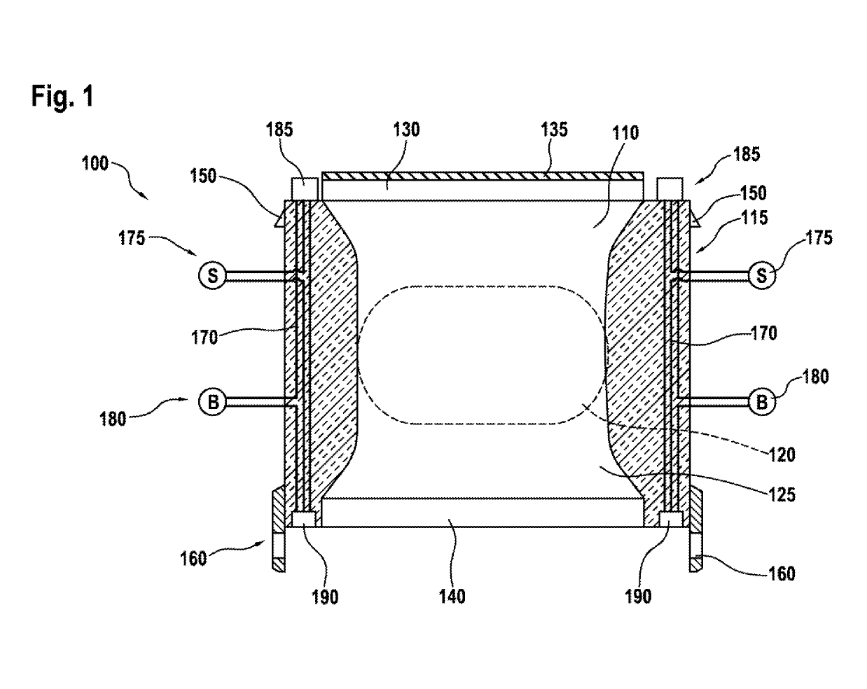

FIG. 1 shows a sectional view of one exemplary embodiment of the present invention as an energy store covering module 100. Energy store covering module 100 is provided to cover a cell, which is not shown in FIG. 1, of an electrochemical energy store. For example, such a cell may be a battery cell or a rechargeable battery cell of a rechargeable lithium-ion battery which is not subdivided further and has a defined opening including a protective closure, which a fluid in the cell penetrates during a defect of the battery cell, or of the rechargeable battery cell, so that the fluid escapes from the cell. Such fluids are generally aggressive and harmful to health and, for example, attack a material which they reach or damage body parts with which they come in contact. To be able to collect such fluids after a defect of one cell and deliberately discharge them, energy store covering module 100 provided in the present application is now used, which offers the above-mentioned functions.

Energy store covering module 100 (referred to as module 100 in the abbreviated form in the following description, also for the sake of simplicity) includes a cavity 110 in a cover 115 which is coupleable via a reception orifice 120 to the battery cell or the rechargeable battery cell. Reception orifice 120 (which is illustrated as dotted in FIG. 1) should be situated directly over a cell blow-out diaphragm of the cell, which is destroyed when a defect of the battery cell, or of the rechargeable battery cell, occurs and frees or releases a fluid from the cell to the surroundings. Reception orifice 120 is situated on a main surface 125 of module 100, this main surface 125 being situated in a plane above the drawing plane of FIG. 1.

Cavity 110 is furthermore accessible from outside the module for a fluid via a first transfer opening 130, or a fluid present in cavity 110 is able to exit the module via first transfer opening 130. First transfer opening 130 is situated in a different wall of cover 115 than reception orifice 120. In particular, first transfer opening 130 is situated in a wall of cover 115 which forms a side wall in relation to main surface 125, for example, at a right angle to main surface 125. A sealing element 135, which is integrally molded or inserted into cover 115, is further situated around first transfer opening 130 and makes a fluid-tight connection between module 100 and a further module possible during assembly of module 100 with a further module. In this way it may be ensured that a fluid which leaves cavity 110 via first transfer opening 130 is not able to escape to the surroundings of module 100, but is introduced into a corresponding transfer opening of the further module situated on or attached to module 100.

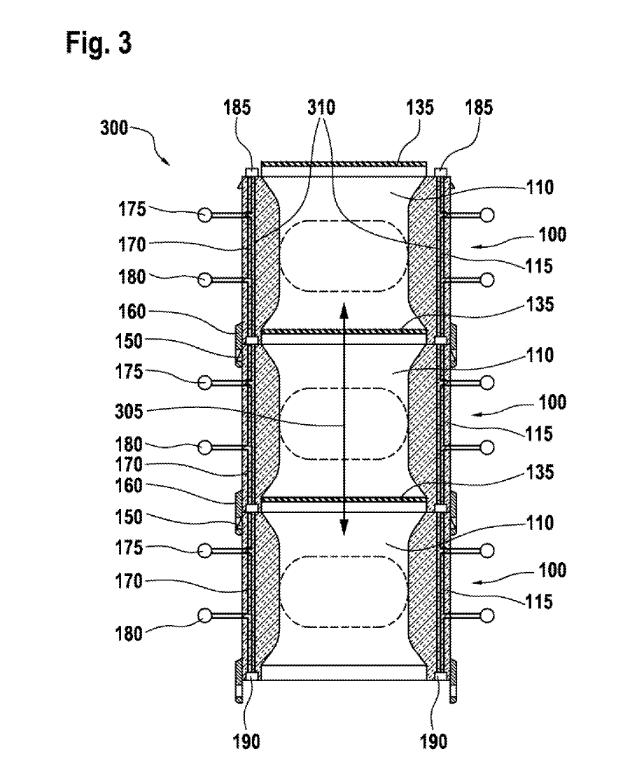

A second transfer opening 140 is furthermore situated in the module shown in FIG. 1, which is situated opposite first transfer opening 130 or is situated in a wall of cover 115 situated opposite a wall of cover 115 having first transfer opening 130. Cavity 110 is also fluid-permeably coupled to an exterior of module 100 via this second transfer opening 140, second transfer opening 140 advantageously also being coupled to a transfer opening of a further module, which is not shown in FIG. 1, and being able to receive a fluid from this further module in cavity 110 of module 100 shown in FIG. 1. In this way, a consecutive connection of multiple modules 100, as they are shown in FIG. 3, for example, may thus be used to create a fluid channel due to the cavities which are fluidically coupled to each other via the transfer openings of the respective modules in question, a fluid exiting one or multiple cells during a defect in these corresponding cells being able to be discharged via this fluid channel.

To create a preferably secure and stable connection between individual modules 100 to be interconnected, as they are shown by way of example in FIG. 1, one or multiple detent(s) 150 may be provided laterally on cover 115 in the area of first transfer opening 130. At the same time, one or multiple snap-fit hooks 160 may be situated on cover 115, for example in the area of second transfer opening 140. If two modules 100 are now connected, for example, as they are shown in FIG. 1, such as by pressing second transfer opening 140 of the second module against sealing element 135 and by pressing first transfer opening 130 of module 100 shown in FIG. 1, detents 150 of module 100 are able to engage in corresponding snap-fit hooks of the further module and thus fix the further module with module 100 from FIG. 1, as it is shown in FIG. 3, for example. Detent(s) 150 and snap-fit hooks 160 thus form one or multiple connecting element(s) for the secure and stable connection of module 100 to a further module, these two modules advantageously then being connected to each other in a fluid-tight manner to prevent the fluid to be conducted in cavities 110 and transfer openings 130 and 140 from escaping. Connecting element 150 and 160, or connecting elements 150 and 160, may be designed in one piece with cover 115, for example by joining a corresponding mold for cover 115 with corresponding connecting elements 150 and 160 in an injection molding process using a plastic material. In this way module 100 is very cost-effective to manufacture in a highly standardized form, whereby the manufacturing costs of a unit formed by the connection of multiple such modules 100 may be reduced.

Moreover, it is favorable if an electrical signal line 170 is embedded into such a module 100, a voltage sensor 175 for monitoring a cell voltage of the energy store already being connected, or at least being connectable, to the signal line, for example. Such a signal line 170 may also already be connected, or be connectable, to a sensor 180 for monitoring the battery or rechargeable battery. For example, such a sensor 180 may detect a concentration, or even a presence, of a fluid present in cavity 110, whereby such a sensor 180 could detect a defect in at least one cell which is fluidically connected to cavity 110. To obtain a signal bus when assembling multiple modules 100 designed according to FIG. 1, signal line 170 may include a first interface 185 in the area of first transfer opening 130, or adjoining a detent 150 (in particular between first transfer opening 130 and detent 150), at which signal line 170 is electrically contactable from outside module 100. With the aid of the first interface, a signal is thus transmittable from sensor 175, or from sensor 180, via signal line 170 to a signal line of a further module. For example, sensors 175 and 180 may in each case be connected in series in a separate but signal line 170. To be able to also transmit signals via signal line 170 which are supplied by sensors of a further module 100, a second interface 190 should also be provided, which is designed for electrical contacting of signal line 170 from outside module 100 and which is situated, for example, in the area of second transfer opening 140 or of snap-fit hook 160 (more precisely, for example, between second transfer opening 140 and snap-fit hook 160). It is thus possible for a signal of a sensor of a further module, which is coupled in the area of second transfer opening 140 to module 100 from FIG. 1, to also be transmitted via signal line 170 of the module shown in FIG. 1.

To be able to achieve a preferably high redundancy and thus high reliability during the transmission of signals, moreover a further signal line 170, which is identical to signal line 170, (and corresponding interfaces 185 and 190) may be provided in module 100, as it is shown on the right side of cover 115 in FIG. 1, for example. For example, signal line 170, or both signal lines 170, may already be situated during the manufacture of module 100, for example by inserting corresponding electrical conductors or sensors into a mold for the creation of module 100, and by then filling the molds with a corresponding plastic material in an injection molding process.

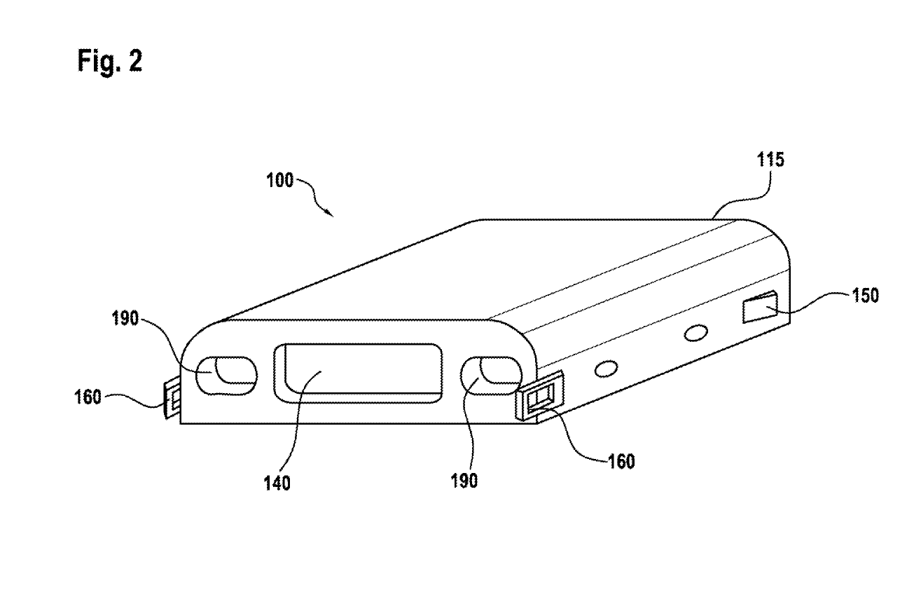

FIG. 2 shows a symmetrical or perspective illustration of a single module, a side wall having second transfer opening 140 and openings for the second interface(s) being shown. The particular area of module 100 which is connected to the cell via reception orifice 120 is not apparent in FIG. 1, since this area is situated under cover 115 shown in FIG. 1.

FIG. 3 shows a sectional representation in a top view onto an exemplary interconnection of three energy store covering modules to form an energy store covering unit 300 according to one exemplary embodiment of the present invention. It is easily apparent from FIG. 3 how a fluid channel 305 is formed by the fluid-permeable connection of cavities 110 of the individual modules 100 corresponding to the illustration of FIG. 1 via the particular transfer openings 130 or 140 of modules 100 in question, a fluid being dischargeable via this fluid channel across a longer distance upon exiting a defective cell. It is likewise apparent that also signal lines 170 are interconnected via corresponding interfaces 185 and 190 to form a signal bus 310 in each case, which is able to relay signals of sensors 175 and 180 of the particular modules 100.

An important aspect of the present invention according to one exemplary embodiment of the present invention is therefore to replace the two separate and complex components for degassing and for voltage monitoring with a modular concept, made of plastic material for example, which may do without an additional wiring harness and is adaptable to different module sizes (having different cell numbers) due to standardized components.

The approach presented here by way of example introduces a modular system made of plastic material for degassing cells, into which the signal lines and the corresponding sensors for condition monitoring are or may be integrated and which is made up of individual identical modules 100. These modules 100 may easily be combined, depending on the module size, i.e., the number of cells per modules, by being plugged together. In this way both the contact between signal lines 170 and the media guidance 110 and 305 is established. These are then led out on terminal modules and may be connected to neighboring modules in the battery pack. With the aid of the approach presented here, only a few different components are required to be able to cover all module and pack sizes for cells of an electrochemical energy store, with which considerable cost savings regarding the component and assembly costs are associated.

The corresponding modules 100 are constructed in the form of plug connectors 150 and 160, as can be seen in FIG. 1. In this way, multiple modules 100 may easily be interconnected using snap-fit connections 150, 160 and adapted to arbitrary cell module sizes in a modular system. The length of modules 100 depends on the corresponding cell type. Degassing modules 100 are implemented in such a way that they offer a preferably gas-tight connection to the cell and are hollow, so that multiple modules 100 together create a shared degassing channel 305. Snap-fit connection 150, 160 presses the inserted or integrally molded seal 135 against the next module 100 and thus generates a gas-tight connection between modules 100. At the end of one or multiple battery modules, which were interconnected to form a ventilation system, channel 305 is closed with end caps, which are not shown in the figures, which ensure the connection to the gas discharge of the battery housing and the electrical contact to the monitoring electronics. In addition, electrical lines 170 and sensors 175, 180, or only connection possibilities for sensors, may be provided in degassing module 100 to also be able to implement the cell monitoring. The electrical contacting may also be implemented in the form of plug connectors 185, 190. For this purpose, arbitrary sensors 175, for example for voltage or temperature monitoring, for connection to or for integration into module 100 are possible.

According to one additional variant, a sensor 180 may also be situated in the gas discharge line, the sensor monitoring the temperature or the composition of the air to provide an additional indicator for the damage of a battery cell. This could be integrated into module 100 shown here by way of example with low complexity. The attachment of modules 100 to the battery cells or battery modules may also be carried out with the aid of a snap-fit and/or press-fit connection (which is not shown in greater detail in the figures for the sake of clarity), so that the assembly complexity during assembly of a battery pack is very low or is fully automatable. These degassing and monitoring modules 100 are preferably manufactured using injection molding. In this way, high quantities are possible at inexpensive prices. By directly inserting plug components 185, 190 and signal lines 170, for example in the form of lead frames, into the injection molding tool, it is possible to produce the highly integrated modules 100 in one operation, without additional assembly steps being necessary.

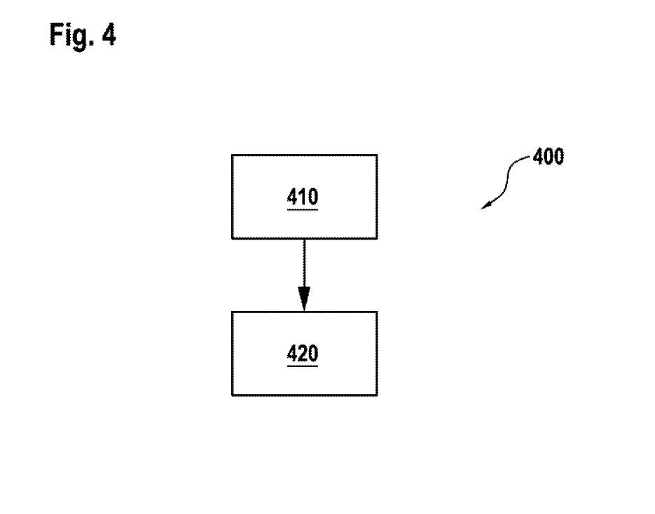

FIG. 4 shows a flow chart of one exemplary embodiment of the present invention as a method 400 for assembling an energy store covering unit 300. Method 400 includes a step of connecting 410, in a fluid-tight manner, at least one first energy store covering module to a second energy store covering module with the aid of a connecting element of the first energy store covering module, the cavity of the cover of the first of the energy store covering modules being fluid-permeably connected to the cavity of a second of the energy store covering modules with the aid of the transfer opening of the first energy store covering module to form the energy store covering unit. The method further includes a step of attaching 420, in a fluid-tight manner, the formed energy store covering unit to at least one first and one second electrochemical energy store cell, so that the reception orifice of the first energy store covering module is situated adjoining an outlet opening for a fluid exiting during a defect of the electrochemical energy store cell, and so that the reception orifice of the second energy store covering module is situated adjoining an outlet opening for a fluid exiting during a defect of the second electrochemical energy store cell.

The approach presented here for manufactured modules 100 may be used, for example, in any lithium-ion battery module for electric vehicles and hybrid vehicles.

The described exemplary embodiments shown in the figures are selected only by way of example. Different exemplary embodiments may be combined with each other completely or with respect to individual features. It is also possible to supplement one exemplary embodiment with features of another exemplary embodiment.

Moreover, method steps according to the present invention may be carried out repeatedly and in a different order than the one described.

If one exemplary embodiment includes an “and/or” link between a first feature and a second feature, this should be read in such a way that the exemplary embodiment according to one specific embodiment includes both the first feature and the second feature, and according to an additional specific embodiment includes either only the first feature or only the second feature.

1-10. (canceled)

11. An energy store covering module for covering a cell of an electrochemical energy store unit, comprising:
a cover, which on one side has a reception orifice to a cavity for receiving a fluid exiting an electrochemical energy store, the cover including at least a first lateral transfer opening which is fluidically connected to the cavity for discharging fluid present in the cavity; and
at least one first connecting element for connecting the cover to a further energy store covering module.

12. The energy store covering module as recited in claim 11, wherein the cover and the connecting element are produced in one piece from a plastic material.

13. The energy store covering module as recited in claim 12, wherein the cover further includes at least one sealing element around the first lateral transfer opening.

14. The energy store covering module as recited in claim 12, wherein the energy store covering module further includes at least one second lateral transfer opening for discharging fluid present in the cavity, which is situated on a side of the cover opposite the first lateral transfer opening, the second lateral transfer opening being fluidically connected to the cavity, and wherein a second connecting element is provided which is situated on the side of the cover on which the first connecting element is situated.

15. The energy store covering module as recited in claim 12, wherein the cover includes at least one electrically conductive signal line configured to transmit at least one signal of at least one sensor, the signal line including at least one first interface for electrically connecting the signal line to outside the cover, the interface being situated on the side of the cover on which the first lateral transfer opening is situated, and wherein at least one of (i) a sensor which is coupled to the signal line is provided, and (ii) at least one sensor interface which reads in the signal and which is electrically conductively connected to the signal line is provided.

16. The energy store covering module as recited in claim 15, wherein the cover includes at least one second interface for externally contacting the signal line, the at least one second interface being situated on a side of the cover opposite the first interface.

17. An energy store covering unit, comprising:
at least two energy store covering modules each configured for covering a cell of an electrochemical energy store unit, each energy store covering module having:
a cover, which on one side has a reception orifice to a cavity for receiving a fluid exiting an electrochemical energy store, the cover including at least a first lateral transfer opening which is fluidically connected to the cavity for discharging fluid present in the cavity; and
at least one first connecting element for connecting the cover to a further energy store covering module;
wherein the at least two energy store covering modules are connected in a fluid-tight manner with the aid of the at least one first connecting element of a first one of the energy store covering modules, the cavity of the cover of the first one of the energy store covering modules being fluid-permeably connected to the cavity of a second one of the energy store covering modules with the aid of the transfer opening of the first one of energy store covering modules.

18. The energy store covering unit as recited in claim 17, wherein each of the energy store covering modules includes an electrically conductive signal line transmitting at least one signal of at least one sensor, the electrically conductive signal lines being electrically conductively connected to each other via respective interfaces of each of the energy store covering modules to form a signal bus.

19. A method for assembling an energy store covering unit having at least two energy store covering modules each configured for covering a cell of an electrochemical energy store unit, the method comprising:
connecting, in a fluid-tight manner, at least one first energy store covering module to a second energy store covering module with the aid of a connecting element of the first energy store covering module, a cavity of a cover of the first energy store covering module being fluid-permeably connected to a cavity of a second energy store covering module with the aid of a transfer opening of the first energy store covering module to form the energy store covering unit; and
attaching, in a fluid-tight manner, the energy store covering unit to first and second electrochemical energy store cells, so that a reception orifice of the first energy store covering module is situated adjoining an outlet opening for a fluid exiting upon an occurrence of a defect of the first electrochemical energy store cell, and so that the reception orifice of the second energy store covering module is situated adjoining an outlet opening for a fluid exiting upon an occurrence of a defect of the second electrochemical energy store cell.
